(19) United States
(12) Patent Application Publication
(10) Pub. No.: US 2025/0066938 A1
(43) Pub. Date: Feb. 27, 2025

(54) POROUS TRANSPORT LAYER FOR WATER ELECTROLYSIS, AND METHOD FOR MANUFACTURING THE SAME

(71) Applicants: Hyundai Motor Company, Seoul (KR); Kia Corporation, Seoul (KR)

(72) Inventor: Young June Park, Gyeonggi-do (KR)

(21) Appl. No.: 18/596,770

(22) Filed: Mar. 6, 2024

(30) Foreign Application Priority Data
Aug. 24, 2023 (KR) 10-2023-0111403

(51) Int. Cl. C25B 13/05; C25B 1/04; C25B 9/23; C25B 11/032

(52) U.S. Cl. CPC C25B 13/05; C25B 1/04; C25B 9/23; C25B 11/032

(57) ABSTRACT

Provided are a porous transport layer for water electrolysis including a first layer containing first particles of a titanium group element, and a second layer containing second particles of a titanium group element. An average diameter of the first particles is larger than an average diameter of the second particles, and a surface of the first layer abutting the second layer is planarized. A method for manufacturing the same is also provided.

### CROSS-REFERENCE TO RELATED APPLICATION

This application claims under 35 U.S.C. § 119(a) the benefit of Korean Patent Application No. 10-2023-0111403, filed in the Korean Intellectual Property Office on Aug. 24, 2023, the entire contents of which are incorporated herein by reference.

### BACKGROUND

### Technical Field

The present disclosure relates to a porous transport layer for water electrolysis, in which diameters of generated oxygen bubbles are small and thus the bubbles may be easily discharged to a separator, and that may prevent problems such as a decreased performance or an increased pressure due to a decreased introduction of a reactant, and a method for manufacturing the same.

### Background

A polymer electrolyte membrane PEM water electrolysis system is an electro-chemical conversion device that uses electricity to decompose water (H₂O) into hydrogen (H₂) and oxygen (O₂). The PEM water electrolysis system is operated at a high current density, produces hydrogen and oxygen of a high purity as a gas permeation through the solid electrolyte membrane is low, and has a high stability. The PEM water electrolysis system commonly includes a PEM water electrolysis stack and a peripheral device for driving the same, and the PEM water electrolysis stack includes a plurality of PEM water electrolysis cells.

The PEM water electrolysis cell commonly includes a membrane-electrode assembly MEA including an electrolyte membrane, an anode electrode, and a cathode electrode, and a gas diffusion layer GDL for a cathode, a porous transport layer PTL for an anode, a separator for the cathode, and a separator for the anode. Then, water introduced through a separator passage for the anode is supplied to the anode through the PTL, and a hydrogen gas generated by the cathode is discharged through the GDL and the separator passage for the cathode. In the electrochemical reaction of the PEM water electrolysis cell, the water supplied to the anode is separated into hydrogen ions (H+) and electrons along with an oxygen gas through an oxygen evolution reaction (OER), and then flows to a cathode through an electrolyte membrane and an external circuit, generates a hydrogen gas through a hydrogen evolution reaction.

The PTL functions to uniformly distribute and/or diffuse that water that is a reactant on a surface of the anode electrode, and discharge oxygen generated in an anode electrode to an outside through a separator, and collects and/or delivers electrons generated through an electrochemical reaction. To maximize functions of the PTL, various physical properties, such as a corrosion resistance, an electrical conductivity, a distribution and diffusion, a low surface roughness, and a mechanical strength are essential.

### PRIOR ART DOCUMENT

### Patent Document

(Patent Document 1) Korean Patent No. 1939666 (Publication Date: Mar. 8, 2018)

(Patent Document 2) Japanese Patent Publication No. 2022-151916 (Publication Date: Oct. 12, 2022)

### SUMMARY

The present disclosure has been made to solve the above-mentioned problems occurring in the prior art while advantages achieved by the prior art are maintained intact.

An exemplary embodiment of the present disclosure provides a porous transport layer for water electrolysis, in which diameters of generated oxygen bubbles are small and thus the bubbles may be easily discharged to a separator, and that may prevent problems such as a decreased performance or an increased pressure due to a decreased introduction of water which is a reactant, and a method for manufacturing the same.

The technical problems to be solved by the present disclosure are not limited to the aforementioned problems, and any other technical problems not mentioned herein will be clearly understood from the following description by those skilled in the art to which the present disclosure pertains.

According to an exemplary embodiment, a porous transport layer for water electrolysis includes a first layer containing first particles of a titanium group element, and a second layer containing second particles of a titanium group element, and an average diameter of the first particles is larger than an average diameter of the second particles, and a surface of the first layer abutting the second layer is planarized.

The planarized surface of the first layer may have a surface roughness (Sa) of about 1.0 μm to about 10.0 μm.

The titanium group element may comprise at least one selected from the group consisting of titanium (Ti), zirconium (Zr), and hafnium (Hf).

The average diameter of the first particles may be about 10 μm to about 80 μm.

The average diameter of the second particles may be about 5 μm to about 70 μm.

The average diameter of the second particles may be smaller than the average diameter of the first particles by about 3 μm to about 60 μm.

The first layer may have an average thickness of about 10 μm to about 500 μm, or the second layer has an average thickness of about 10 μm to about 500 μm.

Each of the first layer and the second layer, respectively, may further comprise one or more selected from the group consisting of nickel group elements, stainless steel (SUS), titanium (Ti), iron (Fe), and an alloy thereof.

According to an exemplary embodiment, a water electrolysis cell including the porous transport layer for water electrolysis is provided. A separator for an anode may be laminated on the first layer of the porous transport layer for water electrolysis. A membrane-electrode assembly (MEA) may be laminated on the second layer of the porous transport layer for water electrolysis.

According to an exemplary embodiment, a method for manufacturing a porous transport layer for water electrolysis includes an operation of forming a first layer and a second layer respectively from first layer forming slurry containing first particles of a titanium group element and a second layer forming slurry containing second particles of a titanium group element, a surface treating operation of planarizing at least one surface of the first layer, and an operation of laminating the second layer on one surface of the first layer, on which the surface treatment has been performed, an average diameter of the first particles is larger than an average diameter of the second particles.

A surface roughness (Sa) of one surface of the first layer may be set to about 1.0 to about 10.0 μm through the surface treatment; the average diameter of the first particles may be about 10 μm to about 80 μm; the average diameter of the second particles may be about 5 μm to about 70 μm; or the average diameter of the second particles may be smaller than the average diameter of the first particles by about 3 μm to about 60 μm.

The surface treatment may comprise one or more methods selected from the group consisting of a cold isostatic pressing (CIP) method, a warm isostatic pressing (WIP) method, a rolling method, and a grinding method.

Each of the first layer and the second layer may be respectively formed through at least one application method selected from the group consisting of dipping coating, doctor blade coating, comma coating, screen printing coating, and slot die coating, gravure coating, lip coating, cap coating, bar coating, and tape casting.

Each of the first layer forming slurry and the second layer forming slurry, respectively, may further comprise a solvent, a dispersant, and a binder.

The first layer forming slurry may comprise about 60 to about 98 parts by weight of the first particles, about 10 to about 30 parts by weight of the solvent, about 0.1 to about 3 parts by weight of the dispersant, and about 0.1 to about 4 parts by weight of the binder.

The second layer forming slurry may comprise about 60 to about 98 parts by weight of the second particles, about 10 to about 30 parts by weight of the solvent, about 0.1 to about 3 parts by weight of the dispersant, and about 0.1 to about 4 parts by weight of the binder.

The forming the first layer and the second layer, and the operation of laminating the second layer may be performed through a roll-to-roll scheme.

The forming the first layer and the second layer may comprise forming a first green sheet and a second green sheet through an application process respectively using the first layer forming slurry containing the first particles of the titanium group element and the second layer forming slurry containing the second particles of the titanium group element; and degreasing the first green sheet and the second green sheet respectively.

As discussed, the method and system suitably include use of a controller or processer.

### BRIEF DESCRIPTION OF THE DRAWINGS

The above and other objects, features and advantages of the present disclosure will be more apparent from the following detailed description taken in conjunction with the accompanying drawings:

FIG. 1 is a cross-sectional view of a typical polymer electrolyte membrane (PEM) water electrolysis cell;

FIG. 2 is a cross-sectional view schematically illustrating problems that may occur when no surface treatment for planarization is performed;

FIG. 3 is a cross-sectional view of a porous diffusion layer according to an exemplary embodiment of the present disclosure; and

FIG. 4 is a cross-sectional view of a water electrolysis cell according to an exemplary embodiment of the present disclosure.

### DETAILED DESCRIPTION

In the specification, when it is described that a part “includes” a certain component, this means that it may further include other components rather than excluding other components, unless specifically stated to the contrary.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In the specification, when it is described that a member is located on a “surface,” “one surface,” “an opposite surface,” or “opposite surfaces” of another member, this means not only that a member contacts another member, but also there is another member between the two members.

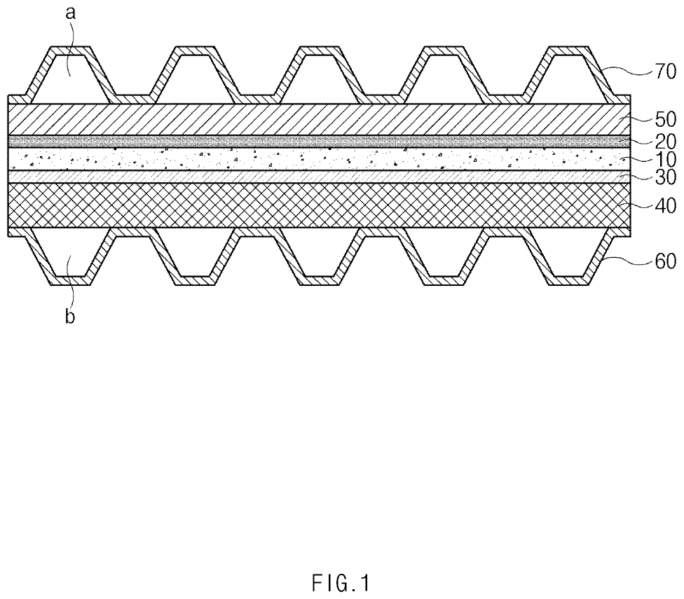

Referring to FIG. 1, a PEM water electrolysis cell commonly includes a membrane-electrode assembly MEA including an electrolyte membrane 10, an anode electrode 20, and a cathode electrode 30, a gas diffusion layer GDL 40 for the cathode, a porous transport layer PTL 50 for the anode, a separator 60 for the cathode, and a separator 70 for the anode. Includes. Then, water that is introduced through a separator passage “a” for the anode is supplied to the anode 20 through the PTL 50, and a hydrogen gas that is generated by the cathode 30 is discharged through the GDL 40 and the separator passage “b” for the cathode. In an electrochemical reaction of the PEM water electrolysis cell, the water that is supplied to the anode is separated into hydrogen ions (H+) and electrons along with an oxygen gas through an oxygen evolution reaction (OER), and then flows to the cathode though an electrolyte membrane and an external circuit, and generates a hydrogen gas through a hydrogen evolution reaction.

The PTL functions to uniformly distribute and/or diffuse the water that is a reactant on a surface of the anode electrode, discharge oxygen that is generated in the anode electrode to an outside through a separator, and collect and/or deliver electrons that are generated by the electrochemical reaction. To maximize functions of the PTL, various properties, such as a corrosion resistance, an electrical conductivity, a distribution and diffusion, a low surface roughness, and a mechanical strength, are essentially necessary.

Then, a material having an excellent electrical conductivity, thermal conductivity, and corrosion resistance, and a low Ohmic resistance and mass transport loss is preferable for the PTL. Accordingly, a conventional PTL usually includes titanium (Ti) that has excellent physical and chemical characteristics because it does not corrode even under a high potential and acidic condition. However, the water is not uniformly supplied to the anode due to a difference in partial pressures of water that flows into the PTL depending on a shape of the anode separator passage “a”.

As an alternative measure to this problem, various methods for controlling a horizontal pore shape of a contact surface between the PTL and the anode have been proposed. For example, Korean U.S. Pat. No. 1,939,666 (Patent Document 1) discloses a method for manufacturing an anti-corrosion gas diffusion layer using a titanium fiber, and a gas diffusion layer that is manufactured therefrom. However, in the GDL or the PTL that is manufactured by using the titanium fibers as in Patent Document 1, the fibers are broken and generate pinholes in the electrolyte membrane in kW-class water electrolysis cells that operate at a high temperature and a high pressure whereby cross-over of the cathode and/or the anode may be caused and durability may deteriorate due to a short circuit in the system.

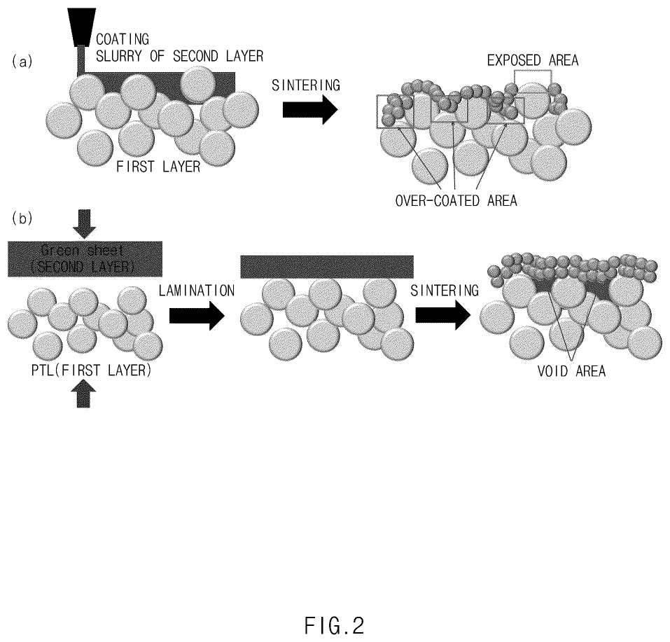

Furthermore, Japanese Patent Publication Application No. 2022-151916 (Patent Document 2) discloses a titanium porous plate including a sintered body of titanium or a titanium alloy, and the titanium porous plate has a structure, in which a first layer and a second layer are laminated in a thickness direction thereof, and an average pore diameter of the second layer is larger than an average pore diameter of the first layer. However, when a first layer is manufactured using a first slurry as in Patent Document 2 and then a second layer is manufactured on the first layer by using a second slurry, it is difficult to manufacture the second layer with a uniform thickness due to titanium powder included in the first layer (see “a” of FIG. 2). Furthermore, even when the layers, rather than the slurries, are manufactured and then laminated, a void space may be caused due to a large surface roughness of the first layer whereby an oxygen gas is trapped (see “b” in FIG. 2).

In detail, as illustrated in “a” of FIG. 2, when the surface roughness of the first layer is large, some areas (in which it protrudes) are not coated, or some areas (in which it is recessed) have pores as the slurries are concentrated in a direction of gravity whereby clogging may occur. Furthermore, when coating is not applied, the advantages of the multi-layer structure are lost, and in over-coated dense areas, pores may become clogged and quality deviations, such as multi-phase fluid diffusion becoming uneven may occur.

Furthermore, as illustrated in FIG. 2B, when a lamination process is used, the second layer may be formed to have a uniform thickness, but a void space is caused between the first layer and the second layer whereby oxygen is trapped and a capillary pressure increases, and thus oxygen may not be properly removed, and as a result, the inflow of a reactant is impeded, and thus a performance thereof may decrease or a pressure may increase.

Furthermore, second particles of smaller diameters may enter between the pores of the first layer, and thus, a third layer containing the first particles and the second particles may be formed, and thus, a mass transfer resistance and a differential pressure increase whereby quality deviations may occur.

Accordingly, by adjusting diameters of the generated oxygen bubbles, they may be easily discharged to the separator, and the water that is a reactant may be introduced, whereby a porous transport layer having an excellent performance of the water electrolysis cell including the same may be manufactured, and thus, researches and development of a method for manufacturing the porous transport layer having an excellent workability, low performance deviation of the manufactured product and quality deviation by locations, and an excellent economic performance due to application of in a roll-to-roll scheme have been required.

### Porous Transport Layer for Water Electrolysis

The porous transport layer for water electrolysis according to the present disclosure includes a first layer containing first particles of a titanium group element, and a second layer containing second particles of a titanium group element, wherein an average diameter of the first particles is larger than an average diameter of the second particles, and a surface of the first layer, which is abutting the second layer, may be planarized. Then, the first layer may have a higher porosity than the second layer, or an average pore diameter of the first layer may be larger than an average pore diameter of the second layer.

As described above, the porous transport layer in the present disclosure includes the first layer and the second layer, which contain the particles having different average diameters, wherein the diameter of the generated oxygen bubbles may be adjusted such that the oxygen bubbles are easily discharged to the separator, a performance of the water electrolysis cell including the same may be further enhanced by facilitating the inflow of the water that is the reactant, and the membrane-electrode assembly MEA that is an adjacent component may be protected. Furthermore, a surface of the first layer, which is abutting the second layer, is planarized whereby the second layer may be easily manufactured to have a uniform thickness, and thus, a workability may become excellent, a thickness deviation of the manufactured product may decrease, a performance variation and a quality variation by locations may decrease.

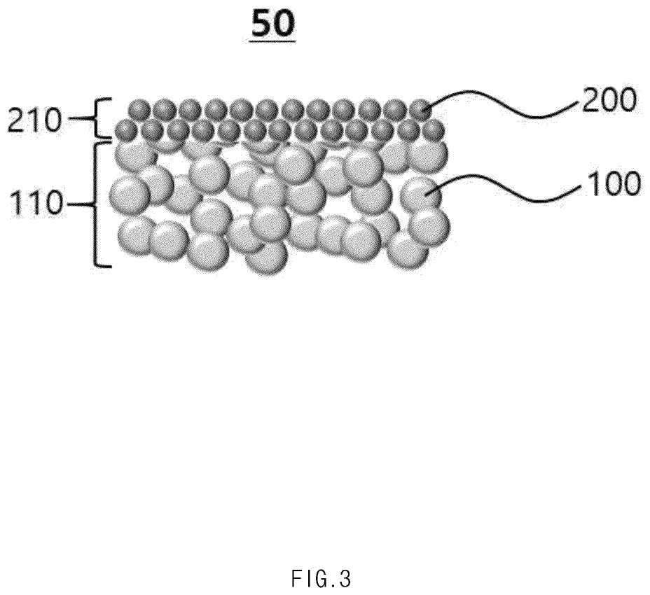

Referring to FIG. 3, the porous transport layer 50 for water electrolysis according to the present disclosure may include a first layer 110 including first particles 100, and a second layer 210 including second particles 200.

### First Layer

The first layer functions to distribute and diffuse the water that is the reactant into the PTL when it is introduced, and smoothly discharge the oxygen generated by the anode electrode to an outside through the separator.

The surface of the first layer, which is abutting the second layer, is planarized. Accordingly, a roughness of a surface of the first layer on the side that contacts the second layer may be adjusted, and thus, the second layer to be easily manufactured to have a uniform thickness, whereby an excellent workability is ensured, and a thickness deviation, a performance deviation, and a quality deviation for locations decrease.

Furthermore, the planarized surface of the first layer may have a surface roughness (Sa) of 1.0 μm to 10.0 μm, or 1.5 μm to 5.0 μm. When the surface roughness of the planarized first layer is less than the above range, the roughness is excessively low and a difficulty in manufacturing is very high whereby it cannot be manufactured, a process performance may decrease, or process costs may increase. Meanwhile, when it is more than the above range, the second layer is formed to have an uneven thickness, and a thickness deviation of the final product that is the PTL is excessive whereby proper bonding is not achieved between the PTL and the MEA on the surface that contacts the MEA, and thus a surface pressure is uneven or the oxygen gas generated in a non-bonding area may be trapped and prevent an introduction of the water that the reactant, and thus a performance may deteriorate.

The first layer may contain the first particles of a titanium group element.

Furthermore, the titanium group element of the first layer, for example, may include at least one selected from the group consisting of titanium (Ti), zirconium (Zr), and hafnium (Hf). In detail, the titanium group element of the first layer may include titanium. Then, the first layer may further include nickel (Ni) and/or stainless steel (SUS) to save raw materials.

The first particles may be commonly used without particular restrictions as long as they have a shape that may be used when the PTL is manufactured, for example, they may be circular, oval, or irregular.

Furthermore, the first particles may have an average diameter of 10 μm to 80 μm, 10 μm to 60 μm, or 10 μm to 50 μm. When the average diameter of the first particles is less than the above range, a porosity of the manufactured first layer is too low or the pore diameter is too small, whereby introduction of the water and discharge of oxygen are not smooth, and thus, a high mass transfer resistance is caused and a performance is lowered in a high current section. Meanwhile, when it is more than the above range, the porosity of the manufactured first layer is too large whereby a process performance in forming the second layer deteriorates, and a fluid diffusivity is low, and thus, the performance decreases. Then, the average diameter of the first particles may be a diameter of 50% of a cumulative distribution (D50) in a diameter distribution that is measured by using a particle size analyzer PSA.

The average diameter of the second particles is smaller than the average diameter of the first particles. For example, the average diameter of the second particles may be smaller than the average diameter of the first particles by 3 μm to 60 μm, 5 μm to 50 μm, or 5 μm to 40 μm. When a difference between the average diameter of the first particles and the average diameter of the second particles is less than the above range, acquisition thereof due to the use of double layers (the first and second layers) to protect the membrane-electrode assembly, increase mass transfer, and control sizes of the oxygen bubbles may be decreased, and when the above range is exceeded, appearance defects, such as bending, may occur due to different thermal contraction rates of the layers during heat treatment and sintering (that is, due to differences in thermal contraction rates).

The first layer may have an average thickness of 10 μm to 500 μm, 30 μm to 400 μm, or 30 μm to 300 μm. When the average thickness of the first layer is less than the above range, the stiffness of the manufactured product may be low whereby a handling performance deteriorates or an easy breakage occur, or a process performance may deteriorate when the second layer is formed, and when it is more than the above range, the thickness of the final product may become too high, and thus the mass transfer resistance may be increased.

Furthermore, the first layer may have an average pore diameter of 3 μm to 40 μm, 5 μm to 30 μm, or 8 μm to 25 μm. When the average pore diameter of the first layer is less than the above range, the pore diameter of the first layer is too small that the introduction of the water and the discharge of oxygen are limited, and when it is more than the above range, the surface roughness of the first layer is high whereby it may be difficult to form the second layer, or the second layer forming slurry may permeate into the pores of the first layer, or the thickness of the final product has a large deviation when the second layer is formed. Then, the average pore diameter of the first layer may be a pore size that is measured through a mercury intrusion pore size analysis.

### Second Layer

The second layer may directly contact with the membrane-electrode assembly MEA, function to spread the water that is the reactant introduced from the first layer uniformly into the membrane-electrode assembly, and adjust the generated oxygen gas while generating a direct OER reaction to an appropriate diameter to easily discharge oxygen.

The second layer includes the second particles of a titanium group element.

Furthermore, the titanium group element of the second layer, for example, may include at least one selected from the group consisting of titanium (Ti), zirconium (Zr), and hafnium (Hf). In detail, the titanium group element in the second layer may include titanium. Then, the second layer may further include nickel (Ni) and/or stainless steel (SUS) to save raw materials.

The second particles may be commonly used without particular restrictions as long as they have a shape that may be used to manufacture the PTL, for example, they may be circular, oval, or irregular.

Furthermore, the second particles may have an average diameter of 5 μm to 70 μm, 6 μm to 60 μm, or 7 μm to 45 μm. When the average diameter of the second particles is less than the above range, the pore size of the second layer is too small or the porosity is too low whereby paths for the introduction of water and the discharge of the generated oxygen bubbles are excessively decreased, and thus, the performance may decrease, and the roughness on the contact surface with the MEA may be excessively high above the range, and thus problems, such as damage to the MEA or increased contact resistance, may be caused. Then, the average diameter of the second particles may be the diameter of 50% of the cumulative distribution (D50) in the diameter distribution that is measured by using the particle size analyzer PSA.

The second layer may have an average thickness of 10 μm to 500 μm, 20 μm to 400 μm, or 30 μm o 300 μm. When the average thickness of the second layer is less than the above range, a performance may be decreased because a space for properly diffusing the reaction fluid and the produced fluid is not provided, and when it is more than the above range, the thickness of the PTL, which is the final product, is excessively high and the material transfer resistance may become too high and the performance of the porous transport layer may decrease in the high current section.

Furthermore, the second layer may have an average pore diameter of 3 μm to 30 μm, 4 μm to 20 μm, or 5 μm to 10 μm. When the average pore diameter of the second layer is less than the above range, the porosity of the second layer is too low or the pore diameter is too small whereby the introduction of the water and the removal of oxygen bubbles may be limited, and when it is more than the above range, the surface roughness may increase, damaging the MEA, or the size of oxygen bubbles may increase, limiting the introduction of the water. Then, the average pore diameter of the second layer may be the pore size that is measured through a mercury intrusion pore size analysis.

Each of the first layer and the second layer may respectively further include one or more selected from the group consisting of a nickel group element, stainless steel (SUS), titanium (Ti), iron (Fc), and an alloy thereof.

The above-described porous transport layer for water electrolysis according to the present disclosure may have small diameters of the generated oxygen bubbles whereby they be easily discharged into the separator, and the water that is the reactant may be easily introduced whereby the performance of the water electrolysis cell containing it is excellent. Furthermore, according to the porous transport layer for water electrolysis, each layer may be easily manufactured with a uniform thickness, whereby a performance variation and a location-specific quality variation in water electrolysis cells containing it are low.

### Water Electrolysis Cell

The water electrolysis cell of the present disclosure may include a porous transport layer as described above.

For example, the separator for an anode may be laminated on the first layer of the porous transport layer for water electrolysis. Furthermore, the membrane-electrode assembly MEA may be laminated on the second layer of the porous transport layer for water electrolysis.

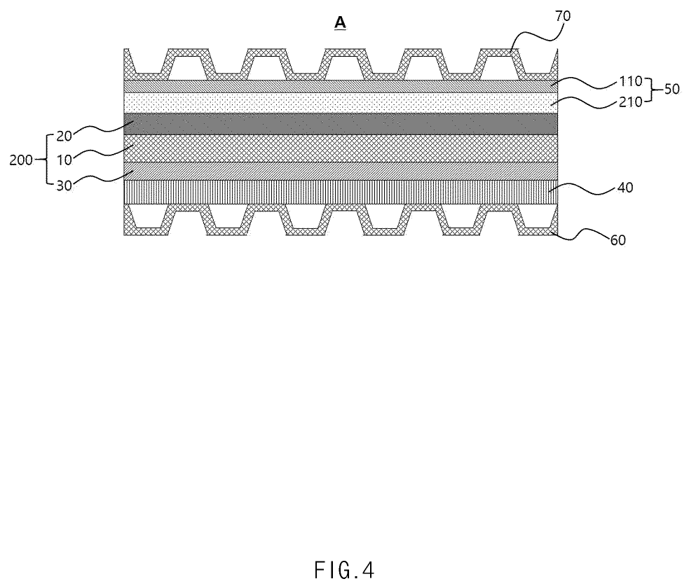

In detail, referring to FIG. 4, the water electrolysis cell “A” according to the present disclosure may include a form, in which the separator 70 for an anode, the porous transport layer PTL 50 including the first layer 110 and the second layer 210, the membrane-electrode assembly (MEA) 200 including the anode electrode 20, the electrolyte membrane 10, and the cathode electrode 30, the gas transport layer GDL 40, and the separator 60 for the cathode are sequentially laminated.

### Method of Manufacturing Porous Transport Layer for Water Electrolysis

The method for manufacturing a porous transport layer for water electrolysis according to the present disclosure may include an operation of forming a first layer and a second layer respectively from first layer forming slurry containing first particles of a titanium group element and a second layer forming slurry containing second particles of a titanium group element, a surface treating operation of planarizing at least one surface of the first layer, and an operation of laminating the second layer on one surface of the first layer, on which the surface treatment has been performed.

### Operation of Forming First Layer and Second Layer

In this operation, the first layer and the second layer are formed respectively from the first layer forming slurry containing the first particles of the titanium group element and the second layer forming slurry containing the second particles of the titanium group element.

The average diameter of the first particles is larger than the average diameter of the second particles. Then, the shapes and the average diameter of each of the first particles and the second particles of the titanium group element are the same as described in the porous transport layer.

Each of the first layer forming slurry and the second layer forming slurry may respectively further include a solvent, a dispersant, and a binder.

### <First Layer Forming Slurry>

The solvent serves to improve a workability by adjusting a viscosity of the slurry. Then, the solvent may be commonly used without particular limitation as long as it is a solvent that may be used for the production of the PTL, and, for example, may include ethanol or toluene.

Furthermore, the solvent may be included in an amount of 10 to 30 parts by weight, 15 to 30 parts by weight, or 20 to 30 parts by weight with respect to 100 parts by weight of the first layer forming slurry. When a content of the solvent in the first layer forming slurry is less than the above range, a viscosity of the first layer forming slurry is high and a coating property deteriorates whereby the thickness of the first layer is formed unevenly or a porosity for locations of the first layer and/or a deviation of a pore size may become excessive, and when it is more than the above range, materials and equipment may be contaminated due to excessive evaporation of the solvent during sintering, or it may be difficult to match a targeted thickness, porosity, and/or pore size.

The dispersant may improve the dispersion of the first particles in the slurry and helps form a coating film of a uniform composition. Then, the dispersant may be commonly used without particular limitation as long as it is used when the PTL is manufactured, for example, may include one or more selected from the group consisting of water, ethanol, methanol, isopropanol, xylene, cyclohexanone, acetone, toluene, and methyl ethyl ketone.

Furthermore, the dispersant may be included in an amount of 0.1 to 3 parts by weight, 1 to 3 parts by weight, or 1.5 to 2.3 parts by weight with respect to 100 parts by weight of the first layer forming slurry. When a content of the dispersant in the first layer forming slurry is less than the above range, the first particles may agglomerate with each other when the slurry is manufactured, and when it is more than the above range, a viscosity of the slurry is too low whereby a workability of the coating process is insufficient.

The binder may improve the bonding force between the first particles in the slurry and helps easily manufacture it into a sheet shape. Then, the binder may be commonly used without particular limitation as long as it is used when the PTL is manufactured, for example, may include one or more selected from the group consisting of polyvinyl butyral (PVB), polyvinyl alcohol (PVA), polyvinyl chloride (PVC), polyvinyl acetate (PVAc), and polyacrylonitrile.

Furthermore, the binder may be included in an amount of 0.1 to 4 parts by weight, 1 to 4 parts by weight, or 2 to 3.5 parts by weight with respect to 100 parts by weight of the first layer forming slurry. When the content of the binder in the first layer forming slurry is less than the above range, the bonding force between the first particles in the manufactured first layer is insufficient where it is difficult to maintain the sheet shape, and when it is more than the above range, the adhesion of the ingredients in the slurry is excessively strong whereby it is stuck to a lower substrate.

In detail, the first layer forming slurry may include 60 to 98 parts by weight of the first particles, 10 to 30 parts by weight of the solvent, 0.1 to 3 parts by weight of the dispersant, and 0.1 to 4 parts by weight of the binder with respect to 100 parts by weight of slurry. In more detail, the first layer forming slurry may include 65 to 90 parts by weight or 70 to 85 parts by weight of the first particles, 15 to 30 parts by weight or 20 to 30 parts by weight of the solvent, and 1 to 3 parts by weight or 1.5 to 2.3 parts by weight of the dispersant, and 1 to 4 parts by weight or 2 to 3.5 parts by weight of the binder.

When the content of first particles in the first layer forming slurry is less than the above range, a distance between the first particles may be long during the heat treatment process whereby sintering does not occur smoothly, or the porosity of the manufactured first layer may be too high or the stiff may be low, and when the above range is exceeded, the porosity of the manufactured first layer may be too low or the viscosity of the slurry may be too high, whereby it is impossible to manufacture the first green sheet normally.

Furthermore, the first layer forming slurry may be manufactured by mixing and stirring the first particles, the solvent, the dispersant, and the binder, in detail, through a ball mill process. Then, a stirring time period may be 1 hour or more, 10 to 30 hours, 12 to 24 hours, or 18 to 24 hours, but the present disclosure is not limited thereto and may be any time period that allows for uniform mixing.

The first layer forming slurry may have a viscosity of 1,000 to 8,000 cP, 1,500 to 7,500 cP, or 1,800 to 7,000 cP at 25° C. When the viscosity of the first layer forming slurry at 25° C. is within the above range, a slurry application workability is excellent and a thickness of the manufactured first layer may be formed uniformly. Furthermore, when the viscosity of the first layer forming slurry at 25° C. is less than the above range, the surface roughness of the first layer increases due to the uneven thickness of the manufactured first layer, and when it is more than the above range, the slurry application workability may be insufficient.

### <Second Layer Forming Slurry>

The solvent, the dispersant, and the binder in the second layer forming slurry are as described in the solvent, the dispersant, and the binder in the first layer forming slurry, and the solvents, the dispersants, and the binders in the slurries may be the same or different from each other.

Further, the solvent may be included in an amount of 10 to 30 parts by weight, 15 to 30 parts by weight, or 20 to 30 parts by weight with respect to 100 parts by weight of the second layer forming slurry. When the content of the solvent in the slurry for forming the second layer is less than the above range, the viscosity of the second layer forming slurry is high and a coating performance decreases, a thickness of the second layer is formed to be uneven or a deviation of porosities and/or pore sizes for locations of the second layer may be excessive, and when it is more than the above range, materials and equipment may be contaminated due to excessive evaporation of the solvent during sintering, or it may be difficult to match the targeted thickness, porosity, and/or pore size.

The dispersant may be included in an amount of 0.1 to 3 parts by weight, 1 to 3 parts by weight, or 1.5 to 2.3 parts by weight with respect to 100 parts by weight of the second layer forming slurry. When a content of the dispersant in the second layer forming slurry is less than the above range, the second particles agglomerate with each other when the slurry is manufactured, and when it is more than the above range, the viscosity of the slurry is too low and a workability of performing the coating process is insufficient.

Furthermore, the binder may be included in an amount of 0.1 to 4 parts by weight, 1 to 4 parts by weight, or 2 to 3.5 parts by weight with respect to 100 parts by weight of the second layer forming slurry. When the content of the binder in the second layer forming slurry is less than the above range, it is difficult to maintain the sheet shape due to an insufficient bonding force between the second particles in the manufactured second layer, and when it is more than the above range, an adhesion of the ingredients in the slurry may be excessively strong, and may be stuck to the lower substrate during the application process.

Specifically, the second layer forming slurry may include 60 to 98 parts by weight of the second particles, 10 to 30 parts by weight of the solvent, 0.1 to 3 parts by weight of the dispersant, and 0.1 to 4 parts by weight of the binder with respect to 100 parts by weight of the slurry. In more detail, the second layer forming slurry may include 65 to 90 parts by weight or 70 to 85 parts by weight of the second particles, 15 to 30 parts by weight or 20 to 30 parts by weight of the solvent, and 1 to 3 parts by weight or 1.5 to 2.3 parts by weight of the dispersant, and I to 4 parts by weight or 2 to 3.5 parts by weight of the binder.

When a content of second particles in the second layer forming slurry is less than the above range, a distance between the second particles is long during the heat treatment process whereby sintering may not be performed smoothly, or the porosity of the manufactured second layer may be too high or the stiffness may be low, and when it is more than the above range, the porosity of the manufactured second layer is too low or the viscosity of the slurry is too high whereby it is impossible to manufacture the second green sheet normally.

Furthermore, the second layer forming slurry may be manufactured by mixing and stirring the second particles, the solvent, the dispersant, and the binder, in detail, through mixing of a ball mill process. Then, the stirring time may be 1 hour or more, 10 to 30 hours, 12 to 24 hours, or 18 to 24 hours, but the present disclosure is not limited thereto and may be any time period that allows for uniform mixing.

The second layer forming slurry may have a viscosity of 1,000 to 8,000 cP, 1,500 to 7,500 cP, or 1,800 to 7,000 cP at 25° C. When the viscosity of the second layer forming slurry at 25° C. is within the above range, the slurry application workability is excellent and the thickness of the manufactured second layer may be formed uniformly. Furthermore, when the viscosity of the second layer forming slurry at 25° C. is less than the above range, the surface roughness of the second layer increases due to the uneven thickness of the manufactured second layer, and when it is more than the above range, the application workability of the slurry may be insufficient.

### <Method for Forming First and Second Layers>

Each of the first layer and the second layer may be respectively formed through at least one application method selected formed the group consisting of dipping coating, doctor blade coating, comma coating, screen printing coating, slot die coating, gravure coating, lip coating, cap coating, bar coating, and tape casting. In detail, each of the first layer and the second layer may be respectively formed through a doctor blade coating method.

In detail, the operation of forming the first layer and the second layer may include an operation of forming a first green sheet and a second green sheet through an application process respectively using the first layer forming slurry containing the first particles of the titanium group element and the second layer forming slurry containing the second particles of the titanium group element, and an operation of degreasing the first green sheet and the second green sheet respectively.

The application process may use any of the methods described above.

For example, in the operation of forming the first layer and the second layer, the first green sheet and the second green sheet may be formed respectively by using a doctor blade method using the first layer forming slurry and the second layer forming slurry, respectively, and when the green sheet is manufactured, an application method using a tape casting method at a speed of 0.3 m/min to 1 m/min may be used. The shape may be adjusted while the green sheet is manufactured, by appropriately locating the doctor blade and release paper such that the slurry may reach an embossed area during the application process.

When the application method as described above is performed, any commonly used and/or purchased release paper may be used without particular restrictions, for example, the release paper may include any one material of polyethylene terephthalate (PET), polyethylene naphthalate (PEN), and polycyclohexane silene dimethylene terephthalate (PCT). Furthermore, the embossed area, that is, the pattern layer, may be used without particular restrictions as long as it is commonly used and/or purchased, for example, may include any one material of low-density polyethylene (LDPE), linear low-density polyethylene (LLDPE), and thermoplastic polyurethane (TPU), unstretched polypropylene (CPP), and polyvinylidene fluoride (PVDF).

Each of the first green sheet and the second green sheet manufactured through the application process may be respectively degreased. That is, each of the first green sheet and the second green sheet manufactured through the application process may be respectively degreased and then laminated. Through the degreasing, it is possible to prevent a slipping phenomenon on the interface between the layers during the lamination.

The solvent in the first green sheet and the second green sheet may be removed through the degreasing treatment. For example, the degreasing treatment may be performed at 300 to 700° C., 350 to 600° C., or 400 to 500° C. under an inert gas atmosphere. When the temperature during degreasing treatment is less than the above range, the solvent may reside while not being evaporated whereby the performance of the PTL may deteriorate, and when it is more than the above range, the titanium element may be oxidized in an environment other than a high vacuum atmosphere whereby the performance of the PTL may deteriorate.

Furthermore, the inert gas may be a commonly used inert gas, for example, may be an argon (Ar) gas.

The degreasing treatment may be performed by raising the temperature at a rate of 1 to 5° C./min or 1 to 3° C./min and maintaining the degreasing treatment temperature for 1 to 4 hours or 1 to 3 hours.

### Surface Treatment Operation

In this operation, a surface treatment may be performed to planarize at least one surface of the first layer.

The surface treatment is to planarize at least one side of the first layer, and a surface roughness of the first layer that is joined to the second layer may be adjusted whereby the second layer may be easily manufactured to a uniform thickness, and thus, the workability becomes excellent and a variation in the performance of the manufactured product and a variation in the qualities for locations are less.

Furthermore, the surface treatment may be performed on opposite sides of the first layer to planarize the opposite sides of the first layer.

The surface treatment may include one or more methods selected from the group consisting of a cold isostatic pressing (CIP) method, a warm isostatic pressing (WIP) method, a rolling method, and a grinding method.

Furthermore, through the surface treatment, the surface roughness (Sa) of one side of the first layer may be set to 1.0 μm to 10.0 μm or 1.5 μm to 5.0 μm. When the surface roughness of the surface-treated first layer is less than the above range, the surface roughness of the first layer is excessively low whereby a manufacturing difficulty is very high and thus, a process performance deteriorates, and when it is more than the above range, the second layer is formed with uneven thickness whereby a thickness deviation of the final product that is the PTL, is excessive and a surface pressure between the PTL and MEA on a surface that contacts the MEA is formed unevenly, and thus, the performance may be low or a non-uniformity problem may occur.

### Operation of Lamination

In this operation, the second layer may be laminated on one surface of the first layer, on which the surface treatment has been performed.

For example, the lamination may be performed through a roll-to-roll method. In detail, the operation of forming the first layer and the second layer and the lamination operation may be performed through the roll-to-roll method. In more detail, in the operation of forming the first layer and the second layer, each of the first layer forming slurry and the second layer forming slurry is respectively used by the roll-to-roll method to form the first green sheet and the second green sheet by using the doctor blade method, and the first green sheet and the second green sheet may be respectively degreased, and the first green sheet and the second green sheet, which has been degreased may be laminated through the roll-to-roll method. As described above, when the PTL is manufactured by applying the roll-to-roll method, the manufacturing method of the present disclosure is economical because the process costs are reduced as compared with the conventional manufacturing method using plating, and has an excellent process efficiency.

Furthermore, a laminate manufactured by laminating the second layer on one surface of the first layer, on which the surface treatment has been performed, may be joined to prevent a slipping phenomenon on the interface of each layer.

The joining may be performed at 100 to 150° C. or 110 to 140° C. while a pressure of 0.1 to 5 MPa or 0.5 to 4 MPa is applied. When the temperature during the joining is more than the above range, that is, during the joining at a high temperature, the solvent and/or the binder in the first and second layers may evaporate and a crack may occur, and when it is less than the above range, a higher load is required whereby an equipment stability decreases or process costs increase.

Furthermore, when the pressure during the joining is more than the above range, the thicknesses of the layers may become thinner, the layers may be broken or mixed whereby the performance of the manufactured water electrolysis cell may deteriorate, and when the pressure is less than the above range, the pore diameter in the manufactured PTL may deviate from a targeted value and thus, the performance may deteriorate.

The manufacturing method may further include an operation of manufacturing a porous transport layer by sintering the laminate after the operation of laminating the layers as described above.

### Sintering Operation

The sintering may be performed at a temperature and a pressure that may be applicable when the PTL is manufactured, for example, at a temperature of 900 to 1,500° C., 950 to 1,400° C., or 1,000 to 1,300° C. Furthermore, the sintering may be performed at a vacuum degree of 10⁻⁵ Torr or less, 10⁻⁸ to 10⁻⁵ Torr, or 10⁻⁷ to 5×10⁻⁶ Torr.

When the temperature during sintering is less than the above range, the titanium group element may not be sintered whereby the pores in the PTL are too large or the stiffness becomes weak, and when the temperature is more than the above range, the titanium group element may be over-sintered and the pores may become clogged.

Furthermore, when the vacuum level during the sintering is less than the above range, the titanium element may be oxidized at the high temperature or the PTL may be contaminated due to contaminants inside the sintering furnace, and when the vacuum level is more than the above range, a higher specification vacuum pump than necessary may be required, and thus, process costs may increase.

The method of manufacturing the porous transport layer according to the present disclosure as described above may be easily manufactured with a uniform thickness, and thus, the performance deviation of the manufactured product and the deviation of the qualities for locations are small, and it is possible to apply the roll-to-roll method, the process costs and process efficiency are very excellent, and thus, it is economical.

According to the porous transport layer of the present disclosure, the generated oxygen bubbles have small diameters whereby the bubbles may be easily discharged into the separator and the water that is a reactant may be easily introduced, and thus, the performance of the water electrolysis cell including the same is excellent.

In addition, according to the manufacturing method of the porous transport layer, the layers may be easily manufactured with a uniform thickness, and thus a workability is excellent, a performance deviation of the manufactured product and a deviation of the qualities for locations are low, and, by applying a roll-to-roll scheme, it has an excellent economic efficiency.

What is claimed is:

1. A porous transport layer for water electrolysis, comprising:
a first layer containing first particles of a titanium group element; and
a second layer containing second particles of a titanium group element,
wherein an average diameter of the first particles is larger than an average diameter of the second particles, and
wherein a surface of the first layer abutting the second layer is planarized.

2. The porous transport layer of claim 1, wherein the planarized surface of the first layer has a surface roughness (Sa) of about 1.0 μm to about 10.0 μm.

3. The porous transport layer of claim 1, wherein the titanium group element comprises at least one selected from the group consisting of titanium (Ti), zirconium (Zr), and hafnium (Hf).

4. The porous transport layer of claim 1, wherein the average diameter of the first particles is about 10 μm to about 80 μm.

5. The porous transport layer of claim 1, wherein the average diameter of the second particles is about 5 μm to about 70 μm.

6. The porous transport layer of claim 1, wherein the average diameter of the second particles is smaller than the average diameter of the first particles by about 3 μm to about 60 μm.

7. The porous transport layer of claim 1, wherein the first layer has an average thickness of about 10 μm to about 500 μm, or the second layer has an average thickness of about 10 μm to about 500 μm.

8. The porous transport layer of claim 1, wherein each of the first layer and the second layer, respectively, further comprises one or more selected from the group consisting of nickel group elements, stainless steel (SUS), titanium (Ti), iron (Fe), and an alloy thereof.

9. A water electrolysis cell comprising the porous transport layer for water electrolysis of claim 1.

10. The water electrolysis cell of claim 9, wherein a separator for an anode is laminated on the first layer of the porous transport layer for water electrolysis.

11. The water electrolysis cell of claim 9, wherein a membrane-electrode assembly (MEA) is laminated on the second layer of the porous transport layer for water electrolysis.

12. A method for manufacturing a porous transport layer for water electrolysis, the method comprising:
forming a first layer and a second layer, respectively, from first layer forming slurry containing first particles of a titanium group element and a second layer forming slurry containing second particles of a titanium group element;
performing surface treatment to planarize at least one surface of the first layer; and
laminating the second layer on one surface of the first layer, on which the surface treatment has been performed,
wherein an average diameter of the first particles is larger than an average diameter of the second particles.

13. The method of claim 12, wherein a surface roughness (Sa) of one surface of the first layer is set to about 1.0 to about 10.0 μm through the surface treatment; wherein the average diameter of the first particles is about 10 μm to about 80 μm; wherein the average diameter of the second particles is about 5 μm to about 70 μm; or wherein the average diameter of the second particles is smaller than the average diameter of the first particles by about 3 μm to about 60 μm.

14. The method of claim 12, wherein the surface treatment comprises one or more methods selected from the group consisting of a cold isostatic pressing (CIP) method, a warm isostatic pressing (WIP) method, a rolling method, and a grinding method.

15. The method of claim 12, wherein each of the first layer and the second layer is respectively formed through at least one application method selected from the group consisting of dipping coating, doctor blade coating, comma coating, screen printing coating, and slot die coating, gravure coating, lip coating, cap coating, bar coating, and tape casting.

16. The method of claim 12, wherein each of the first layer forming slurry and the second layer forming slurry, respectively, further comprises a solvent, a dispersant, and a binder.

17. The method of claim 16, wherein the first layer forming slurry comprises about 60 to about 98 parts by weight of the first particles, about 10 to about 30 parts by weight of the solvent, about 0.1 to about 3 parts by weight of the dispersant, and about 0.1 to about 4 parts by weight of the binder.

18. The method of claim 16, wherein the second layer forming slurry comprises about 60 to about 98 parts by weight of the second particles, about 10 to about 30 parts by weight of the solvent, about 0.1 to about 3 parts by weight of the dispersant, and about 0.1 to about 4 parts by weight of the binder.

19. The method of claim 12, wherein the forming the first layer and the second layer, and the operation of laminating the second layer are performed through a roll-to-roll scheme.

20. The method of claim 19, wherein the forming the first layer and the second layer comprises:
forming a first green sheet and a second green sheet through an application process respectively using the first layer forming slurry containing the first particles of the titanium group element and the second layer forming slurry containing the second particles of the titanium group element; and
degreasing the first green sheet and the second green sheet respectively.
